(19) United States
(12) Patent Application Publication
(10) Pub. No.: US 2015/0252740 A1
(43) Pub. Date: Sep. 10, 2015

(54) EMERGENCY OPERATING MODE FOR A PISTON ENGINE IN AN AIRPLANE

(71) Applicant: Robert Bosch GmbH, Stuttgart (DE)

(72) Inventors: Andreas HEYL, Ludwigsburg (DE); Daniel DAMM, Korntal-Muenchingen (DE); Markus HERBORD, Abstatt (DE); Matthias WETTIG, Talheim (DE); Wilfried FEUCHTER, Kupferzell (DE); Nicolas SOMMER, Tamm (DE)

(21) Appl. No.: 14/640,723

(22) Filed: Mar. 6, 2015

(30) Foreign Application Priority Data
Mar. 6, 2014 (DE) 10 2014 204 115.5

(51) Int. Cl. F02D 29/02

(52) U.S. Cl. CPC F02D 29/02

(57) ABSTRACT

A method is provided for operating a piston engine in an airplane in an emergency operating mode, in which a minimum power output of the piston engine is ensured in that an emergency operating mode is activated that is as much as possible independent of measured values of respective sensors provided for an operation of the piston engine, in which the measured values of the sensors are substituted with firmly specified values. A corresponding airplane is provided as well as to an emergency operation control unit for carrying out the provided method.

### BACKGROUND INFORMATION

Airplane components are subject to considerable stress in operation. In particular, piston engines for driving an airplane as well as sensors required for controlling the piston engine are stressed for example by three-dimensional changes of position as well as by great temperature fluctuations during a flight.

Since a failure of a drive of an airplane or a failure of controls for operating the drive of the airplane during a flight represents a considerable potential risk, the European Aviation Safety Agency requires that a risk of loss of control over a respective drive unit, for example a piston engine, through a fault in a respective control system be sufficiently small.

For maintaining control or power output of a piston engine in the event of a sensor defect for example or similar scenarios that result in a loss of engine output or control over the engine output, mechanical solutions are known in the related art such as for example a use of a constant throttle.

Mechanical solutions for operating a piston engine in an airplane in the event of a malfunction have the disadvantage, however, that they require additional maintenance costs and are consequently themselves likewise susceptible to malfunctions. Mechanical solutions furthermore offer only a limited potential for correction or adaptation to a respective failure scenario.

### SUMMARY

Against this background, a method is provided as well as an airplane having at least one piston engine and an emergency operation control unit for operating a piston engine in an airplane.

Electronic control systems of piston engines evaluate a multitude of sensors in order to optimize a control or regulation at least of one respective piston engine. Examples of parameters that may be used for regulating a respective piston engine are fuel quantity, injection point and ignition firing point. Examples of sensors that may be used for measuring parameters for regulating a piston engine are air pressure sensors, air temperature sensors, fuel pressure sensors, fuel temperature sensors and rotational speed sensors.

A failure or a drift of one or more of such sensors and/or actuators, such as a throttle valve for example, may result in a reduction of a torque or a current power output of a respective piston engine due to complex causal interdependencies. If a fault in an engine control is not detected with sufficient precision, a danger may arise as a result. Even if the respective fault is detected, however, it is a challenge for the respective engine control system how to deal with the detected fault.

The method according to the present invention provides for an emergency operating mode in an electronic control system of a respective piston engine in the event of a malfunction. The present invention provides for a simplified control system of a respective piston engine to be activated, i.e. switched on, in the event of an activation of the emergency operating mode.

The simplified control system functions as much as possible independently of respective sensor values of respective sensors and nevertheless ensures a power output of at least 85% of a respective nominal output of the respective at least one piston engine.

In order to allow for minimum requirements of a power output of a respective piston engine, i.e. a piston engine system, to be satisfied even in the event of an activated emergency operating mode, the present invention provides for the simplified control system to operate on the basis of firmly specified substitute values for respective sensor-dependent operating parameters such that a use of sensors may be omitted as much as possible and a damaging influence of a defective or incorrectly operating sensor is avoided.

By using fixed substitute values, which may be stored for example in a permanent memory such as an EEPROM or a separate control unit, it is possible to allow for an operation of a respective piston engine in a defined and safe operating range even without the use of sensors and/or actuators. For this purpose, the stored substitute values may be collected for example via a test run under controlled conditions such that the emergency operating mode, when activated, allows for a controlled and defined operating mode with a defined minimum power output of the at least one piston engine.

A development may provide for respective sensors comprised by a control system of a respective piston engine to be tested and for substitute values for respective sensors detected as being defective to be used only in the event of a malfunction of a respective sensor.

A development further provides for respective actuators comprised by a control system of a piston engine to be brought into an emergency operating mode, which may be firmly specified for example, so as to ensure an operating state that is optimized for an emergency operation of the respective piston engine. For this purpose, respective pressures in particular may be set to a fixed value, a throttle valve may be opened completely and/or a firmly defined ignition angle may be set via which it is possible to ensure a high or maximum power. It is furthermore conceivable for an ignition to be permanently activated such that a maximum intake-pipe pressure arises and a respective power output is regulated via an injection.

In the case of a piston engine system having multiple piston engines, respective actuators and/or sensors and/or emergency operation control units utilized for regulation are able to regulate individual piston engines, a number of selected piston engines or all piston engines comprised by the piston engine system.

It is furthermore conceivable to maximize a current power output of an electric fuel pump, to move a rail-pressure valve into a maximum position, to set a current propeller angle setting to a defined setpoint value, which does not result in a reduction in power output, and/or to replace respective temperature corrections in a regulation of the respective piston engine with substitute values so as to avoid a reduction in the power output of the respective piston engine or the respective piston engine system.

There may be a further provision for an emergency operation control software to be stored on a separate emergency operation control unit, which evaluates only factors that are essential for an operation of a respective piston engine, such as rotational speed and/or thrust lever position, and calculates from this a fuel quantity that is supplied to the piston engine. All components that are not controlled by the emergency operation control software enter a basic state, which includes for example the states “throttle valve open,” “metering unit in full delivery while simultaneously using a pressure-regulating valve (PCVN)” as well as “turbocharger in a safe intermediate setting to be defined.”

The present invention generally provides for the emergency operating mode to produce a power output that is as high as possible or a high torque of the respective piston engine while using as few measured variables and regulating variables as possible. In aviation it would even be acceptable for the emergency operating mode after some time to result in damage to or even in the destruction of the respective piston engine as long as it is ensured that the piston engine during the emergency operating mode is still operational at least for a defined time period and that the airplane thereby remains maneuverable for a sufficiently long period.

In order to produce a power output of the respective piston engine that is as high as possible in the emergency operating mode, there may be a provision for respective actuators provided for controlling the piston engine to be switched to an emergency operating mode, the emergency operating mode running an operation within respective operating limits that have proven to be very safe for an operation in suitable prior test.

A further development provides for the emergency operating mode to be activated by a button that is connected to a control unit.

In order to activate the emergency operating mode as quickly as possible, another specific embodiment provides for an operation via button that activates a respective control unit, which is provided for example in addition to a control unit required for engine control under standard conditions. Accordingly, the button is able to transfer a respective piston engine or a respective piston engine system into an emergency operating mode.

Another possibility for activating the emergency operating mode is offered by a so-called kick-down switch on a lever for controlling the airplane.

Integrating a switch provided for activating the emergency operating mode into an operational control of a respective pilot makes it possible for the pilot to activate the emergency operating mode quickly and efficiently. For this purpose, the kick-down switch may be developed in such a way for example that a control lever for regulating a power output of a respective piston engine functions within a specific range within the standard conditions and that the emergency operating mode is activated by the control lever when the specific range is exceeded, which may be indicated for example by a mechanical resistance.

The present invention furthermore relates to an airplane having a piston engine and at least one electronic control system, which is configured to control the piston engine using at least one firmly specified value of an operating parameter when an emergency operating mode is activated.

The airplane is in particular designed so that in an activated emergency operating mode of a piston engine comprised by the airplane, a defined minimum power output may be maintained by the piston engine so that an operation of the airplane may be maintained even in the event of a malfunction of the sensor system and/or actuators for example.

The present invention furthermore comprises an emergency operation control unit for operating a piston engine in an airplane, which is configured to control or regulate the piston engine in the event of an activation of an emergency operating mode in such a way that a specified minimum power output of the piston engine is able to be maintained so that the airplane remains maneuverable.

Additional advantages and developments of the present invention derive from the specification and the appended drawings.

It is understood that the features mentioned above and the features yet to be described may be used not only in the individually given combination but also in other combinations or in isolation, without departing from the scope of the present invention.

### BRIEF DESCRIPTION OF THE DRAWINGS

FIG. 1 shows a possible development of a sequence of an activation of an emergency operating mode in an airplane according to one specific embodiment of the method according to the present invention.

FIG. 2 shows a possible development of an airplane according to the present invention having an emergency operation control unit for operating a piston engine comprised by the airplane in an emergency operating mode.

### DETAILED DESCRIPTION

The present invention is represented schematically in the drawings on the basis of specific embodiments and is described in detail below with reference to the drawings.

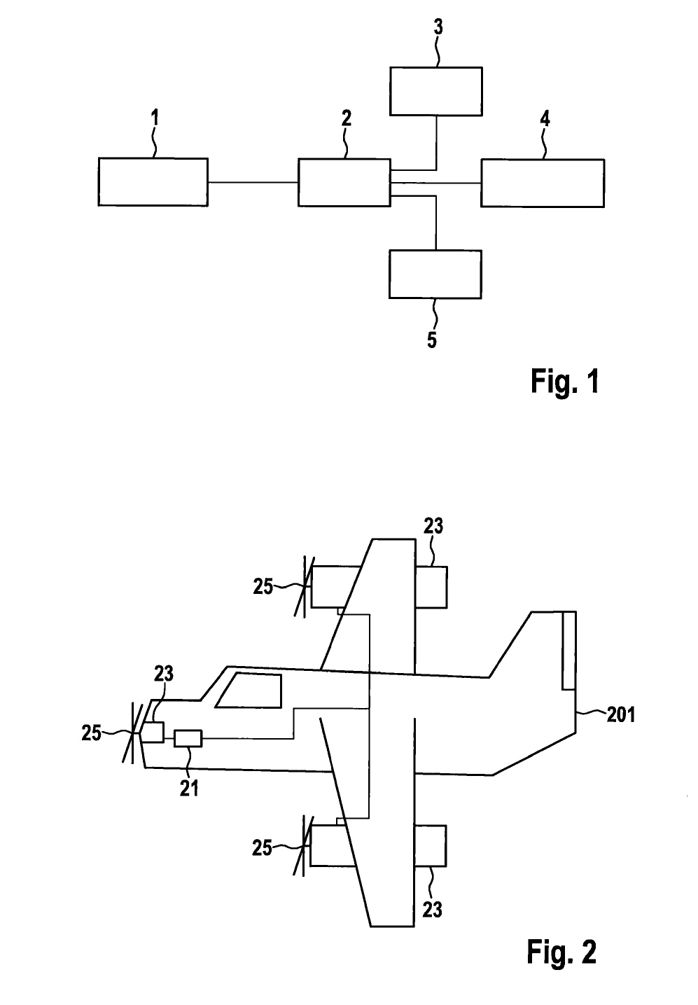

The sequence of the method of the present invention shown in FIG. 1 begins with a method step 1, in which a button is pressed for activating an emergency operating mode, whereupon an emergency operation control unit is activated in a method step 2 and normally a standard control unit is deactivated. In a method step 3, the emergency operation control unit deactivates respective sensors provided for controlling at least one piston engine of an airplane and in a method step 4 sets respective actuators provided for controlling the at least one piston engine to a firmly defined state. Furthermore, respective sensor values of the deactivated sensors are substituted with values permanently stored in the emergency operation control unit.

In a method step 5, the at least one piston engine is regulated by the emergency operation control unit as a function of information about merely a rotational speed and/or a thrust lever position in such a way that the at least one piston engine does not fall below a predefined minimum power output.

By activating the emergency operation control unit consequently an emergency operating mode is activated, which controls or regulates the at least one piston engine in such a way that the at least one piston engine provides sufficient power for maneuvering the airplane at least for a defined period of time. For this purpose, the emergency operation control unit, in the event of a deactivation or failure of the sensors and an associated absence of measured values, uses substitute values permanently stored in the emergency operation control unit. The emergency operation control unit calculates, on the basis of firmly specified values as well as possibly available values regarding rotational speed and thrust lever position, a quantity of fuel optimized for a power output of the at least one piston engine or for a thrust of the airplane, prompts a supply of the at least one piston engine with just this quantity of fuel, and ignites the latter. The piston engine may be a reciprocating engine.

According to the regulating actions of the emergency operation control unit, it is possible to drive an airplane in an emergency situation in the best possible manner and thus to keep it maneuverable.

The airplane 201 represented in FIG. 2 comprises an emergency operation control unit 21 and piston engines 23, which are controlled by emergency operation control unit 21 in the event of an activation of an emergency operating mode in such a way that a minimum level of thrust for airplane 201 or power output is provided by piston engines 23.

In order to maintain the minimum power level or minimum thrust of airplane 201 by piston engines 23, emergency operation control unit 21 modifies values of respective operating parameters of piston engines 23 in such a way that they are regulated in a robust manner, i.e. stably or without great regulating effort.

By activating the emergency operating mode or the emergency operation control unit 21, airplane 201 is still able to be maneuvered even in the event of a malfunction of respective sensors and/or actuators comprised by airplane 201 so as to make it possible to prevent a crash or engine damage.

What is claimed is:

1. A method for operating at least one piston engine in an airplane in an emergency operating mode, in which a minimum power output of the at least one piston engine is ensured, the method comprising:
activating the emergency operating mode that is as much as possible independent of measured values of respective sensors provided for an operation of the at least one piston engine; and
substituting the measured values of the sensors with firmly specified values.

2. The method as recited in claim 1, further comprising storing the firmly specified values in a separate emergency operation control unit that is activated only during the emergency operating mode.

3. The method as recited in claim 1, switching respective actuators provided for an operation of the at least one piston engine into an emergency operating state.

4. The method as recited in claim 3, wherein the emergency operating state is a firmly specified state.

5. The method as recited in claim 1, further comprising activating the emergency operating mode by a button that is connected to at least one control unit.

6. The method as recited in claim 1, further comprising activating the emergency operating mode by a kick-down switch on a lever for controlling the airplane.

7. An airplane, comprising:
at least one piston engine; and
at least one electronic control system that is configured to control the at least one piston engine using at least one firmly specified value of an operating parameter when an emergency operating mode is activated.

8. An emergency operation control unit for operating at least one piston engine in an airplane, comprising:
an arrangement for operating the at least one piston engine, in the event of an activation of an emergency operating mode, in accordance with a method for operating the at least one piston engine in the airplane in the emergency operating mode, in which a minimum power output of the at least one piston engine is ensured, the method comprising:
activating the emergency operating mode that is as much as possible independent of measured values of respective sensors provided for an operation of the at least one piston engine, and
substituting the measured values of the sensors with firmly specified values.
